(19) United States
(12) Patent Application Publication
(10) Pub. No.: US 2024/0246417 A1
(43) Pub. Date: Jul. 25, 2024

(54) Method and Device for Adapting a Display of the Surroundings of a Motor Vehicle

(71) Applicant: Bayerische Motoren Werke Aktiengesellschaft, Muenchen (DE)

(72) Inventors: Bjoern HUPENS, Bad Zwischenahn (DE); Christian LOTTERMANN, Muenchen (DE); Tobias RIESENWEBER, Vierkirchen (DE)

(21) Appl. No.: 18/541,009

(22) Filed: Dec. 15, 2023

(30) Foreign Application Priority Data
Jan. 25, 2023 (DE) 10 2023 101 815.9

(51) Int. Cl. B60K 35/28; G03B 13/36; G06V 20/58; H04N 23/695

(52) U.S. Cl. CPC B60K 35/285; G03B 13/36; G06V 20/58; H04N 23/695; B60K 2360/176

(57) ABSTRACT

A method for adapting a display of the surroundings of a motor vehicle includes: (i) acquiring a first spatial area formed in the surroundings of the motor vehicle having a first partial area and a second partial area by way of a first image sensor; (ii) displaying an image detail which includes the first partial area by way of a display device; (iii) carrying out object recognition on the second partial area by way of an algorithm for object recognition stored in an evaluation device; and (iv) adapting the image detail by way of an algorithm for image processing stored in the evaluation device such that at least the object of the second partial area is displayed by the display device when carrying out the object recognition has had the result that an object is displayed in the second partial area and when the object meets a specified criterion.

### CROSS REFERENCE TO RELATED APPLICATION

This application claims priority under 35 U.S.C. § 119 from German Patent Application No. 10 2023 101 815.9, filed Jan. 25, 2023, the entire disclosure of which is herein expressly incorporated by reference.

### BACKGROUND AND SUMMARY

The present invention relates to a method, in particular a computer-implemented method, and a device for adapting a display of the surroundings of a motor vehicle.

Modern motor vehicles include sensors and cameras, using which signals or spatial areas from the surroundings of the motor vehicle can be acquired. One example of this is assistance systems for parking a motor vehicle. The distances to adjacent vehicles can be acquired by the sensors, on the one hand, and if the distance falls below a threshold value, a signal tone can be output. On the other hand, a camera can also be provided which acquires a view of an adjacent auto during parking and can display it on a display device in an interior of the motor vehicle. A driver of the motor vehicle can therefore be assisted during parking by the output signal tone and by the transmitted view of the adjacent vehicle.

In addition, spatial areas or regions of the surroundings of the motor vehicle acquired by cameras and displayed by the display device can be provided with references, which can also be displayed in the displayed environment in order to assist the driver in a current traffic situation. The supplementation of acquired surroundings with additional references or graphic elements is also known by the term “augmented reality” (AR). In this case, both individual images and live videos can be acquired and displayed, and supplemented by graphic elements.

Due to a use of a camera having a fixed focal length or a previously defined image detail, a specific region can be displayed in this case. Objects or procedures outside this image detail are not acquired.

The present invention is based on the object of further improving the display of the surroundings of the motor vehicle.

A solution to this object is achieved according to the teaching of the claimed invention.

A first aspect of the solution relates to a method, in particular a computer-implemented method, for adapting a display of the surroundings of a motor vehicle, comprising the following steps: (i) acquiring a first spatial area formed in the surroundings of the motor vehicle having a first partial area and a second partial area by way of a first image sensor; (ii) displaying an image detail which includes the first partial area by way of a display device; (iii) carrying out object recognition on the second partial area by way of an algorithm for object recognition stored in an evaluation device; (iv) adapting the image detail by way of an algorithm for image processing stored in the evaluation device such that at least the object of the second partial area is displayed by the display device when carrying out the object recognition has had the result that an object is displayed in the second partial area and if the object meets a specified criterion.

The terms, which are possibly used herein, “comprises”, “contains”, “encloses”, “includes”, “has”, “having”, or any other variant thereof are to cover a nonexclusive incorporation. Thus, for example, a method or a device which comprises or includes a list of elements is not necessarily restricted to these elements, but can contain other elements, which are not expressly listed or which are inherent to such a method or such a device.

Furthermore, “or”, if not expressly indicated to the contrary, relates to an inclusive or and not to an exclusive “or”. For example, a condition A or B is met by one of the following conditions: A is true (or present) and B is false (or not present), A is false (or not present) and B is true (or present), and both A and also B are true (or present).

The terms “a” or “one” as are used herein are defined in the meaning of “a/one or more”. The terms “another” and “a further” and any other variant thereof are to be understood in the meaning of “at least one further”.

The term “plurality” as used herein is to be understood in the meaning of “two or more”.

The term “configured” or “designed” to fulfill a specific function (and respective modifications thereof) as used herein is to be understood to mean that the corresponding device is already provided in a design or setting in which it can execute the function or it is at least settable—i.e., configurable—so that after appropriate setting it can execute the function. The configuration can take place here, for example, via a corresponding setting of parameters of a process sequence or of switches or the like for activating or deactivating functionalities or settings. In particular, the device can include multiple predetermined configurations or operating modes such that the configuration can take place by way of a selection of one of these configurations or operating modes.

The term “image sensor” as used herein is to be understood as an image sensor, in particular a camera, which is capable of sensorially acquiring a scene. In particular, the image sensor can include an electrooptical sensor which is designed to acquire or measure electromagnetic signals and convert them into electrical signals. These sensors can be in particular a charge-coupled sensor, also known as a CCD (Charge-Coupled Device), a radar sensor, a lidar sensor, or another sensor. Moreover, such a sensor can also be designed to emit electromagnetic signals at an object and to in turn measure the electromagnetic signals reflected back from this object, such that in a subsequent evaluation, information can be obtained about the object from the emitted and the reflected electromagnetic signals, also known as a TOF (Time-of-Flight) camera.

The method according to the first aspect makes it possible for the display of an image detail for a motor vehicle to be adapted as a function of a criterion of a recognized object. The display is thus no longer static, but rather is adapted in a dynamic and automated manner, due to which an ascertained relevant object can be displayed to a driver.

Preferred embodiments of the method are described hereinafter, which can each, if not expressly excluded or technically impossible, be combined as desired with one another and with the further described other aspects.

In some embodiments, the method furthermore includes a comparison of the object ascertained by the object recognition with one or more reference objects, wherein the criterion is met when the ascertained object essentially corresponds to one of the reference objects. An adaptation of the display of the image detail thus takes place when the object corresponds with a reference object. A relevant object is thus displayed to a driver in an automated manner, due to which the driver can take this object into consideration in an assessment of a current traffic situation. In particular, the reference object can include another motor vehicle, a road user, a traffic sign, an obstacle in the course of the road, or another, in particular safety-relevant object which can be relevant for the present traffic situation.

In some embodiments, the method furthermore includes determining a distance between the object ascertained by the object recognition and the motor vehicle, wherein the criterion is met when the distance falls below a specified distance. The image detail is thus adapted upon falling below a specified distance, and the driver of the motor vehicle can see the object on the display device. A possible collision with the object can thus be recognized early and avoided. This case can occur, for example, if another motor vehicle performs an unexpected lane change and therefore the distance of the other motor vehicle to the present motor vehicle decreases. The driver is made aware of the other motor vehicle by the display of the recognized other motor vehicle.

In some embodiments, the acquisition of the first spatial area is carried out by imaging the spatial area by way of an objective having variable focal length on the first image sensor, and wherein the adaptation of the image detail is carried out by a reduction of the focal length of the objective. A larger image detail can thus be acquired without the camera having to be changed in its position or alignment.

In some embodiments, the adaptation of the image detail is carried out by adapting an alignment, in particular a rotation and/or a tilt, of the first image sensor, by which the spatial area to be acquired and thus the image detail of the first partial area is adapted. In this way, the first image sensor can be aligned so that in particular the area in which the object is represented is displayed. The alignment can also be selected so that the object is represented in a central area of the acquisition such that the object is also displayed by the display device in a central area, thus essentially in the middle, and the driver can recognize the displayed object faster.

In some embodiments, the adaptation of the image detail is carried out by enlarging the image detail by way of the algorithm for image processing such that in addition to the first partial area, the second partial area is at least partially displayed by the display device. The first spatial area acquired by the first image sensor has a larger area than the first partial area represented by the display device. This can be carried out by previously defined cropping of the first spatial area. By suppressing this cropping, the complete, larger area of the acquired first spatial area can be displayed without a change of the device being required.

In some embodiments, the method furthermore includes: (i) acquiring a second spatial area by way of a second image sensor; (ii) carrying out an object recognition on the second spatial area by way of the algorithm for object recognition stored in the evaluation device; (iii) adapting the image detail by way of the algorithm for image processing stored in the evaluation device such that at least the object of the second spatial area is displayed by the display device when carrying out the object recognition has had the result that an object is represented in the second spatial area and when the object meets a specified criterion. In this way, it is possible for the object to be acquired by a second image sensor. A different spatial area in the surroundings of the motor vehicle can thus be taken into consideration.

A second aspect of the solution relates to a device for adapting a display of an image detail of the surroundings of a motor vehicle, wherein the device is configured to carry out the method according to the first aspect, wherein the device includes: (i) a first image sensor, which is configured to acquire a first spatial area formed in the surroundings of the motor vehicle having a first partial area and a second partial area; (ii) a display device, which is configured to display an image detail which includes the first partial area; (iii) an evaluation device having an algorithm for object recognition, which is configured to carry out object recognition on the second partial area; (iv) wherein the evaluation device furthermore includes an algorithm for image processing which is configured to adapt the image detail such that at least the object of the second partial area can be displayed by the display device when the object recognition has had the result that the second partial area includes an object and when the object meets a specified criterion.

A third aspect of the solution relates to a motor vehicle, including a device according to the second aspect.

The features and advantages explained with reference to the first aspect of the solution also apply accordingly to the further described aspects.

Further advantages, features, and possible applications result from the following description of preferred embodiments in conjunction with the figures.

### BRIEF DESCRIPTION OF THE DRAWINGS

FIG. 1 schematically shows a flow chart to illustrate a method according to one embodiment.

FIG. 2 schematically shows a motor vehicle having a device according to one embodiment.

### DETAILED DESCRIPTION OF THE DRAWINGS

The same reference signs are used throughout the figures for elements which are the same or correspond to one another.

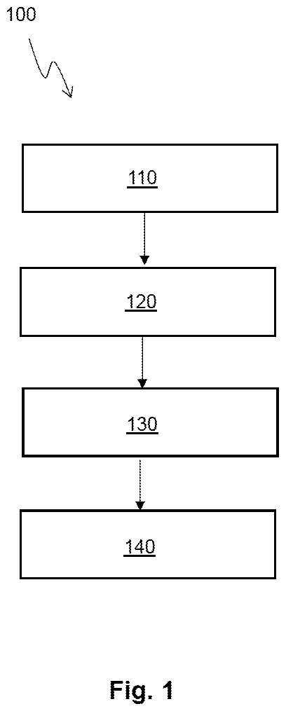

FIG. 1 schematically shows a flow chart to illustrate a method for adapting a display of the surroundings of a motor vehicle according to one embodiment.

In a first step 110 of the method, a first spatial area formed in the surroundings of the motor vehicle 200 having a first partial area and a second partial area is acquired by way of a first image sensor 210, 220.

In a further step 120 of the method, an image detail which includes the first partial area is displayed by a display device.

In a further step 130 of the method, object recognition is carried out on the second partial area by an algorithm for object recognition stored in an evaluation device. Commercially-available software, as is used in modern cameras for the autofocus function, can be used as the algorithm for object recognition.

In a further step 140 of the method, the image detail is adapted by an algorithm for image processing stored in the evaluation device such that at least the object of the second partial area is displayed by the display device when carrying out the object recognition has had the result that an object is represented in the second partial area and when the object meets a specified criterion. The algorithm for image processing can include in this case a known function for adapting an image detail, as has been already used in the meantime in smart phones having cameras.

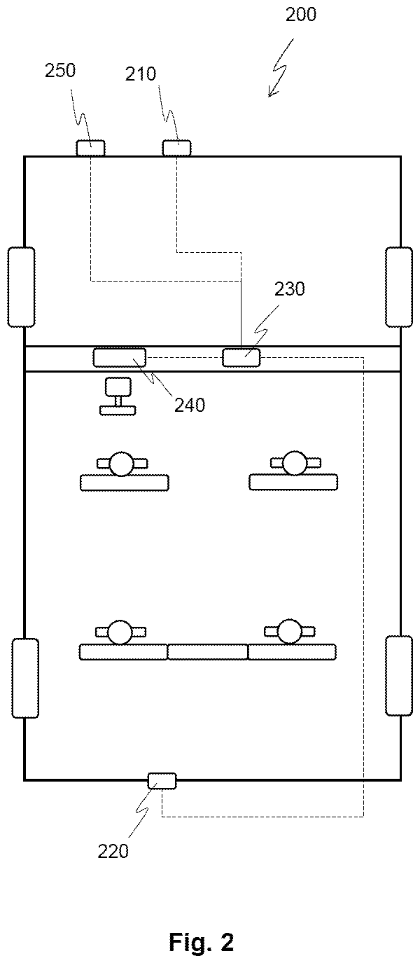

FIG. 2 schematically shows a motor vehicle 200 having a device according to one embodiment. The device includes a first camera 210, a second camera 220, an evaluation device 230, and a display device 240.

The first camera 210 and the second camera 220 are each configured to acquire an image or an image detail of a spatial area of the surroundings of the motor vehicle 200. The first camera 210 and the second camera 220 are each connected to the evaluation device 230 for signaling. The evaluation device 230 is configured to analyze an acquired image detail of the first camera 210 and/or the second camera 220, process it, and send it to the display device 240 for display for the driver.

The display device 240 can in particular include a display screen or a display or also a so-called head-up display, in which content to be displayed is projected for a user into a field of view of the user.

According to the present embodiment, it is provided that initially an image detail is acquired by the first camera 210 and this acquired image detail is processed by an algorithm of the evaluation device 230. Following the processing, the processed image detail is displayed to the driver by the display device 240. In the scope of the processing, the image detail is cropped here such that the displayed image detail is reduced in size in comparison to the acquired image detail. This is because the camera 210 used can have a fixed optical focal length, and the image detail which is to be shown to the driver is to display an essential area and is therefore to be smaller than the acquired image detail. It is thus made possible for the driver to acquire the content of the image detail faster.

The evaluation device 230 furthermore includes an algorithm for object recognition. Using the algorithm, object recognition is carried out on the nonrepresented image detail, which is outside the cropped area. It can be ascertained by the object recognition whether an object is represented on the nonrepresented image detail. An object ascertained in this manner is subsequently compared with reference objects from a database, from which a relevance of the ascertained object can be determined. In the simplest case, exclusively reference objects which are assessed as relevant are stored in the database. If a correspondence of the object is ascertained with one of the reference objects, the ascertained object can thus be assessed as relevant. For example, the ascertained object can be another motor vehicle which is not contained in the cropped image detail, however. If the object corresponds with a reference object, the processing of the acquired image detail is adapted by the evaluation device. The adaptation can take place such that the image detail acquired by the first camera 210 is passed on completely, thus without cropping by the evaluation device 230, to the display device 240. It is also conceivable that the acquired image detail is cropped by the algorithm so that at least the object is contained in the cropped image detail. The recognized object is thus displayed in an automated manner to the driver.

Furthermore, the device can include a distance sensor 250 for acquiring a distance of the motor vehicle 200 to the object. An adaptation of the image detail by the algorithm can also take place here when the object was not represented as a relevant object in the meaning of one of the described reference objects, but the distance of the motor vehicle 200 has fallen below a specified distance to the object.

Furthermore, an object can be acquired by the second camera. It can be ascertained by the evaluation device 230 by way of the described object recognition whether an object, in particular a relevant object, is represented in the image detail ascertained by the second camera 220. In this case, the image detail of the second camera 220 is transmitted to the display device by the evaluation device.

While at least one exemplary embodiment was described above, it is to be noted that a large number of variations thereto exists. It is also to be noted in this case that the described exemplary embodiments only represent nonlimiting examples, and it is not intended that the scope, the applicability, or the configuration of the devices and methods described here be restricted thereby. Rather, the preceding description will supply a person skilled in the art an introduction to the implementation of at least one exemplary embodiment, wherein it is apparent that various changes in the functionality and the arrangement of the elements described in one exemplary embodiment can be performed, without deviating here from the subject matter defined in each of the dependent claims and its legal equivalents.

### LIST OF REFERENCE NUMERALS

100 flow chart to illustrate a preferred embodiment of a method
110 acquiring a spatial area
120 displaying an image detail
130 carrying out object recognition
140 adapting the image detail in dependence on a criterion
200 motor vehicle
210 first camera
220 second camera
230 evaluation device
240 display device
250 distance sensor

What is claimed is:

1. A method for adapting a display of surroundings of a motor vehicle, the method comprising:
acquiring a first spatial area formed in the surroundings of the motor vehicle having a first partial area and a second partial area by a first image sensor;
displaying an image detail which includes the first partial area by a display device;
carrying out object recognition on the second partial area; and
adapting the image detail such that an object of the second partial area is displayed by the display device when carrying out the object recognition has had a result that the object is represented in the second partial area, and when the object meets a criterion.

2. The method according to claim 1, further comprising:
comparing the object ascertained by the object recognition with one or more reference objects, wherein the criterion is met when the ascertained object essentially corresponds with one of the one or more reference objects.

3. The method according to claim 1, further comprising:
determining a distance between the object ascertained by the object recognition and the motor vehicle, wherein the criterion is met when the distance falls below a specified distance.

4. The method according to claim 1, wherein:
the first spatial area is acquired by imaging the spatial area by way of an objective having a variable focal length on the first image sensor, and
the image detail is adapted by reducing the focal length of the objective.

5. The method according to claim 1, wherein the image detail is adapted by adapting an alignment of the first image sensor, by which the spatial area to be acquired and thus the image detail of the first partial area is adapted.

6. The method according to claim 1, wherein the image detail is adapted by enlarging the image detail such that the second partial area is at least partially displayed by the display device.

7. The method according to claim 1, further comprising:
acquiring a second spatial area by way of a second image sensor;
carrying out second object recognition on the second spatial area; and
adapting the image detail such that a second object of the second spatial area is displayed by the display device when carrying out the second object recognition has had a second result that the second object is represented in the second spatial area, and when the second object meets a second criterion.

8. A device for adapting a display of surroundings of a motor vehicle, the device comprising:
a first image sensor, which is configured to acquire a first spatial area formed in the surroundings of the motor vehicle having a first partial area and a second partial area;
a display device, which is configured to display an image detail which includes the first partial area; and
an evaluation device which is configured to carry out object recognition on the second partial area, and to adapt the image detail such that at least an object of the second partial area is displayed by the display device when the object recognition has had a result that the second partial area includes the object, and when the object meets a criterion.

9. A motor vehicle comprising the device according to claim 8.
